(19) United States
(12) Patent Application Publication
(10) Pub. No.: US 2006/0209161 A1
(43) Pub. Date: Sep. 21, 2006

(54) System and method of employing indicia on web material and web material using same

(76) Inventors: Mark Godden, Kingsbridge Devon (GB); Lisa Brant, Durham, CT (US); Thomas Gordon, South Glastonbury, CT (US)

Correspondence Address: MORGAN & FINNEGAN, L.L.P., 3 WORLD FINANCIAL CENTER, NEW YORK, NY, 10281-2101, US

(21) Appl. No.: 10/528,442

(22) PCT Filed: Mar. 29, 2004
(86) PCT No.: PCT/US04/09565

§ 371 Date: Nov. 22, 2005

(30) Foreign Application Priority Data
Mar. 28, 2003 (US) 60458,462

(51) Int. Cl. B41J 2/315; B41M 5/00; G01D 15/10

(52) U.S. Cl. 347/221

(57) ABSTRACT

A donor web for use in a thermal transfer printer comprises a foil having a transfer side and a non-transfer side. A layer of thermal transfer material is disposed on the transfer side of the foil material. Indicia is ink-jetted to the foil. The indicia includes information pertaining to at least one of the length of used foil and the length of unused foil so that an operator can determine whether there is enough foil left for a printing operation. Preferably, the indicia is disposed on the non-transfer side and at a longitudinal edge portion of the foil in order to not affect or otherwise damage the printing portion of the foil. Also, the indicia is preferably white or black ink in order to be clearly visible against various colors of the thermal transfer material. The indicia can also be disposed on a receiver web.

### CROSS-REFERENCE TO RELATED APPLICATION

This application claims the benefit of U.S. Provisional Application No. 60/458,462, filed on Mar. 28, 2003, the disclosure of which is hereby incorporated by reference in its entirety.

### BACKGROUND OF THE INVENTION

1. Technical Field

The present invention relates to web material used in an apparatus for generating an image and, more particularly, to web material having indicia disposed thereon.

2. Background Art

Conventional thermal transfer apparatus for generating an image or a graphic product includes a mechanism for advancing receiver web material, also referred to as sheet or strip material, that will have an image generated thereon, and a mechanism for bringing a thermal printhead in contact with the sheet material such that a donor web material is interposed between the sheet material and the thermal printhead. Conventional donor web material, also referred to as foil or foil material, includes a dear foil with dry transferable film applied to one side thereof. The foil material is typically rolled onto a supply roll and is displaced in foil housing. During a work operation to generate an image, the foil material is pulled from the supply roll onto a take-up roll and the dry transferable film from the foil material is selectively transferred from the foil onto the sheet material through a thermal printing process to generate an image on the sheet material.

The foil material is typically available in numerous colors to generate multicolored images. Each work operation usually requires a predetermined length of foil material of each color. A machine operator is typically required to estimate, by visually observing the supply roll, whether sufficient length of material remains on the supply roll to generate the desired image.

Other methods of determining the length of foil material remaining on the supply roll include estimation aides that allow the operator to make a more educated guess. One such estimation aide is a window formed on an end plug of the supply roll to allow the operator to view the diameter of the remaining foil material. Another estimation aide includes labeling lines formed on the end plug of the supply roll for the operator to estimate remaining length of such foil material based on the labeling lines. However, both of these methods still require estimation. Such estimations are fairly unreliable since the foil is extremely thin, thereby leaving much room for error.

Another method of determining length remaining on the supply roll of the foil material is described in U.S. Pat. No. 5,727,887 assigned to Gerber Scientific Products, Inc., a common assignee with the present application. The disclosure teaches a mechanical gauge disposed within the foil housing to indicate remaining length of the foil. However, such device is relatively expensive to implement and occasionally may be subject to mechanical malfunction.

Although there are several approaches for determining length remaining or used of sheet material, these approaches cannot be easily adapted to the foil material for multiple reasons. The length determining schemes for sheet material are disclosed in U.S. Pat. Nos. 4,708,901, and 4,768,410 assigned to Gerber Scientific Products, Inc., a common assignee with the present application. The '901 and '410 patents disclose a sheet material with code, readable by sensors/computers, to indicate remaining length of the sheet material. However, the foil material is different from and much more sensitive than the sheet material. For example, the foil includes a slippery surface on the non-resin side thereof to ensure that the foil does not adhere to the thermal printhead to avoid any potential damage to the printhead. Therefore, it would not be a simple task to either print or adhere any matter to such slippery surface. Additionally, the foil itself is extremely thin. Thus, if any matter is placed onto the foil, such as a label or heavy ink, it may interfere with the balance and subsequently with the printing process, resulting in potential wrinkling of the foil. Even slight difference in thickness may interfere with the thermal transfer process, resulting in poor quality of the final product. Moreover, interference with the printing area of the foil is also not acceptable. The printing area of the foil must remain free to allow proper printing of the image. Furthermore, since the foil is relatively fragile, it is desirable to minimize handling of the foil.

Additionally, another drawback of existing web material, having a particular code readable by one type of sensor, is that the web material can be used only in one type of apparatus. Thus, the web material having a specific code may not be placed in more than one type of equipment. A further drawback is that the web material must be first loaded into the equipment to determine any information: regarding the material.

Thus, it is desirable to simplify process of determining length remaining on the web material.

### SUMMARY OF THE INVENTION

According to a first aspect of the present invention, a donor web for use in a thermal printer comprises a foil having a transfer side and a non-transfer side. A layer of thermal transfer material is disposed on the transfer side of the foil material. Indicia is ink-jetted to the foil. The indicia includes information pertaining to at least one of the length of used foil and the length of unused foil so that an operator can determine whether there is enough foil left for a printing operation. Preferably, the indicia is disposed on the non-transfer side and at a longitudinal edge portion of the foil in order to not affect or otherwise damage the printing portion of the foil. Also, the indicia is preferably white or black in order to be clearly visible against various colors of the thermal transfer material.

In a second aspect of the present invention, a method of applying indicia on a donor web comprises providing a foil having a transfer side and a non-transfer side. The transfer side includes a layer of thermal transfer material disposed thereon. Indicia is deposited onto the foil during a spooling operation. The indicia includes information about the foil such as, for example, the length of used foil or the length of unused foil. Preferably, the indicia is deposited onto the non-transfer side and at a longitudinal edge of the foil. The indicia is deposited at spaced intervals from each other along a length of the foil. The depositing is preferably accomplished by spraying ink such as, for example, methyl ethyl ketone (MEK) type ink onto the foil. For best results, white or black ink is used in order to be visible against various colors of the thermal transfer material.

In a third aspect of the present invention, a system for applying indicia onto a donor web comprises a slitter apparatus for advancing and cutting a donor web into predetermined widths and advancing the donor web onto supply rolls. The donor web includes a foil having a transfer side carrying a layer of thermal transfer material, and a non-transfer side. At least one inkjet head is for applying indicia onto a longitudinal edge portion of the foil of the donor web at spaced intervals along a length thereof as the web is advanced onto supply rolls. In a preferred embodiment, the system includes a first inkjet for applying white ink and a second inkjet for applying black ink. Preferably, at least one dryer is disposed downstream of the inkjet heads in a direction of donor web advancement along the slitter apparatus for drying ink applied to the foil of the donor web.

In a fourth aspect of the present invention, a donor web cassette for a thermal transfer printer comprises a housing including a supply roll and a take-up roll. A donor web is accommodated by the housing and is coupled to the supply roll and the take-up roll. The housing defines an opening between the supply roll and the take-up roll to expose for viewing a portion of the donor web within the opening. Indicia is ink-jetted to the donor web. The indicia includes information of at least one of a length of used donor web and a length of unused donor web. In a preferred embodiment, the donor web includes a foil having a transfer side and a non-transfer side, wherein a layer of thermal transfer material is disposed on the transfer side of the foil material, and wherein the indicia is ink-jetted to and spaced from one another along a length of the foil. Preferably, the indicia is disposed on the non-transfer side and at a longitudinal edge portion of the foil in order to not affect or otherwise damage the printing portion of the foil. For best results, a color of the indicia is either white or black in order to be visible against various colors of the thermal transfer material.

In a fifth aspect of the present invention, a web for use in a thermal printer comprises a sheet material, and indicia ink-jetted to the sheet material. The indicia includes information of at least one of a length of used sheet material and a length of unused sheet material. The sheet material is either a donor web or a receiver web.

The foregoing and other advantages of the present invention become more apparent in light of the following detailed description of the exemplary embodiments thereof, as illustrated in the accompanying drawings.

### BRIEF DESCRIPTION OF THE DRAWINGS

FIG. 1 is an exploded, side elevational view schematically showing a printing apparatus;

FIG. 2 is a schematic representation of a receiver web with indicia thereon in accordance with the present invention;

FIG. 3 is a schematic representation of donor web material disposed in a cassette having indicia ink-jetted thereon; and

FIG. 4 is a schematic representation of a system for generating indicia on web material in accordance with the present invention.

### DETAILED DESCRIPTION OF THE PREFERRED EMBODIMENTS

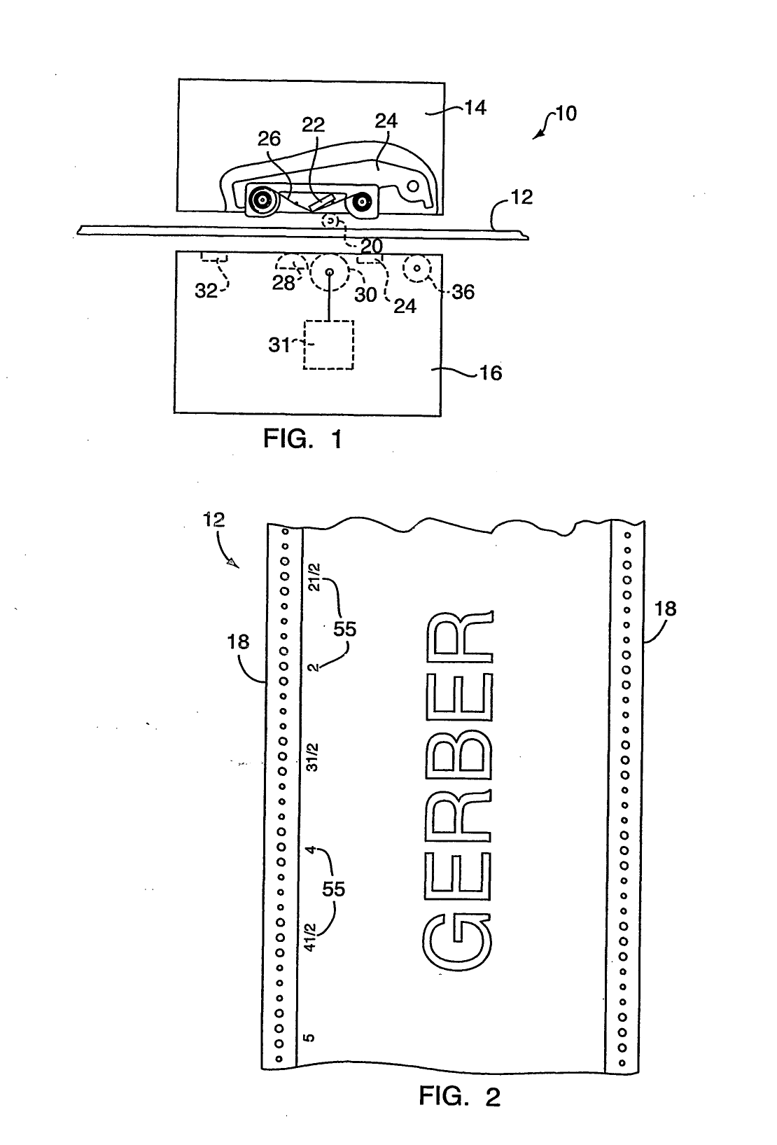

Referring to FIG. 1, an apparatus 10 for generating an image on a receiver web or strip material 12 comprises a top portion 14 and a bottom portion 16. As shown in FIG. 2, the strip material 12 has longitudinal edges 18. The top portion 14 includes a mechanism such as, for example, a pinch roller 20 for advancing the strip material 12. The top portion 14 further includes a printhead 22 and a device, such as a cassette 24, for accommodating a donor web 26 interposed between the printhead and the receiver web 12. The bottom portion 16 includes a stationary or roller platen 28, a friction wheel 30 driven by a motor drive 31, and can optionally include sensors 32, 34 for tracking the longitudinal edges 18 of the strip material 12. Moreover, the bottom portion 16 can include a detector 36, such as an encoder, for tracking an actual longitudinal position of the strip material 12.

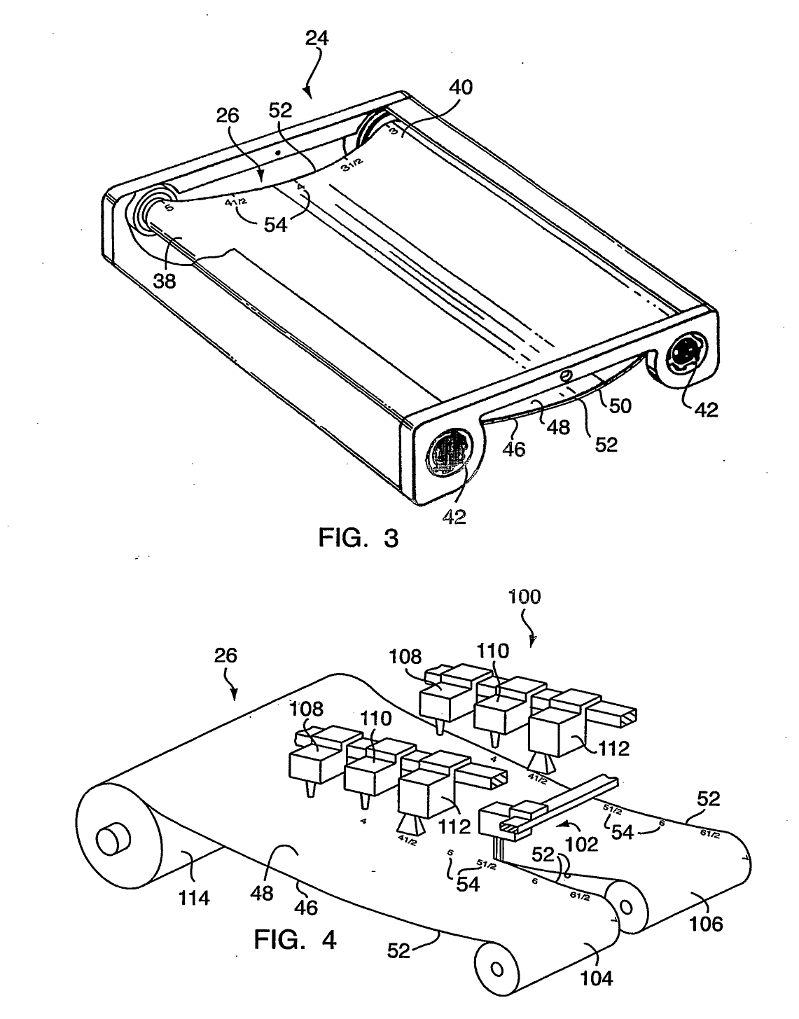

Referring to FIG. 3, the cassette 24 includes a supply roll 38 and a take-up roll 40. The supply roll 38 and the take-up roll 40 each include a core 42 having a donor web 26 wound thereon. The donor web 26 includes a foil having a film or transfer side 46 and a non-film or non-transfer side 48. A dry transferable film or thermal transfer material 50 is disposed on the transfer side 46. The thermal transfer material 50 includes a printable work portion disposed between longitudinal edge portions 52 of the foil.

In one embodiment of the present invention, the foil includes indicia 54 on the non-transfer side 48 and at one of the longitudinal edge portions 52 thereof. The indicia 54 includes information pertaining to the foil. In one embodiment of the present invention, the indicia 54 indicates a length of the foil remaining on the supply roll 38 for consumption during a work operation (i.e., length of unused foil). Alternatively or in addition to the length of unused foil, the indicia 54 can indicate a length of the foil wound on the take-up roll 40 which has already been consumed during one or more previous work operations (i.e., length of used foil). Additionally, the indicia 54 can include information regarding other attributes of the foil such as, for example, the color of the thermal transfer material 50.

As an example, the indicia 54 can indicate in either feet, meters, both, as well as subdivisions thereof, the length that remains on the supply roll 38. The indicia 54 is preferably spaced at predetermined intervals along a length of the foil. The spacing between the indicia 54 can be selected depending upon the application and the desired accuracy of measurement. However, the distance between the indicia 54 should be smaller than the distance between the supply roll 38 and the take-up roll 40. Because the typical length between a supply roll and a take-up roll of a cassette is at least 20 cm, the distance between the indicia 54 is preferably approximately 10 cm (or 100 mm) or less in order to ensure that the indicia is always visible between the supply roll 38 and the take-up roll 40.

In a preferred embodiment of the present invention, the indicia 54 is in either white or black ink to ensure that the indicia is dearly visible against various colors of the thermal transfer material 50 in order to be easily read by an operator, or is otherwise detectable by sensors. However, the indicia 54 can be printed in any color that visibly contrasts with a color of the thermal transfer material 50 without departing from the scope of the present invention. Furthermore, the indicia 54 is preferably disposed within one of the longitudinal edge portions 52 of the foil to ensure that the indicia does not interfere with subsequent image generating process. In a preferred embodiment of the present invention, the indicia 54 is printed on the non-transfer side 46 of the foil.

Referring to FIG. 4, a system 100 for applying the indicia 54 on the donor web 26, in a preferred embodiment of the present invention, includes a conventional slitter apparatus 102. A typical slitter apparatus used during fabrication of foil on the donor web 26 includes a subsystem for applying film onto the foil (not shown) and rolling the foil into a roll. The slitter apparatus 102 cuts the donor web 26 into predetermined widths and then spools the donor web onto supply rolls 104, 106 of predetermined length. The system 100 further comprises at least one inkjet head disposed substantially adjacent to at least one of longitudinal edge portions 52 of the donor web 26. In a preferred embodiment of the present invention, a first inkjet head 108 and a second inkjet head 110 are disposed along each of the longitudinal edge portions 52 of the donor web 26. Preferably, one of the inkjet heads on each side of the donor web 26 is dedicated to forming indicia by spraying white ink, and the other of the inkjet heads on each side of the donor web is dedicated to spraying black ink. However, any color ink that visibly contrasts with a color of the thermal transfer material can be selected without departing from the scope of the present invention. The color of the ink to be sprayed is user selectable and is chosen based on which color ink is determined by the operator to be more effectively visible against the various colors of the thermal transfer material.

Although any type of continuous ink-jet device can be used, one type of system that is preferred is Video Jet manufactured by Video Jet Systems, Inc. The device includes an encoder for establishing placement of the indicia on the web material. Optionally, a dryer 112 is disposed downstream of an associated pair of inkjet heads 108, 110 in the direction of web advancement along the slitter apparatus 102 for drying the ink sprayed thereon. Preferably, the dryer 112 is a conventional hot air dryer. Although the inkjet heads 108, 110 and the dryer 112 are shown positioned upstream of the slitter apparatus 102 relative to the direction of web movement, it should be understood that the inkjet heads and the dryer can be positioned downstream of the slitter apparatus without departing from the scope of the present invention.

In operation, once the foil material is fabricated by applying film onto the foil and rolled into a roll, the roll of the foil material is placed into the slitter apparatus 102. The slitter apparatus 102 quickly spools the foil material from an original roll 114 onto the supply rolls 104, 106 in predetermined lengths while also cutting the foil material into predetermined widths. During this spooling operation, at least one of the inlet heads 108, 110 prints the indicia 54 on an associated longitudinal edge portion 52 of the foil at spaced intervals of, for example, approximately 10 cm, indicating a length remaining on the supply roll or a length wound on the take-up roll. The indicia preferably includes characters or numbers, as shown in FIG. 4, which can be visibly read by an operator. The characters can be oriented as shown or rotated 90 degrees relative to that illustrated in order to minimize the width of the characters, and thereby ensure that the characters do not interfere with the functional area occupied by the thermal transfer material. The dryers 112 can be used to ensure that the sprayed ink for forming the indicia 54 is dried prior to the foil being rolled onto the supply rolls 104, 106. The necessity for a dryer is determined by the operating speed of the slitter apparatus 102. For example, in some situations, the foil material is spooled at 140 meters per minute. At such speeds, it is preferable to use a dryer to ensure that the ink is dry prior to being spooled.

One advantage of the present invention is that the information regarding remaining length of usable foil material is easily visible to an operator. Additionally, the length remaining information is precise and accurate and does not require guesswork and estimation. Furthermore, the ink-jetted indicia does not require additional hardware within the foil housing that can be expensive and subject to potential mechanical and/or electrical failure.

Although applying length remaining indicia onto the foil material by a process of ink-jetting has multiple benefits, these are various reasons against applying ink onto the foil. First, the non-film side of the foil usually includes a slip coating such that the slippery surface of the foil does not adhere to the thermal printhead to avoid potential damage to the printhead. Additionally, the foil is extremely thin and sensitive. Thus, if the balance of the foil is effected even slightly, the foil is subject to wrinkling during work operations. One type of ink that can effectively be used and is adherable is methyl ethyl ketone (MEK) type ink.

Furthermore, it is critical to ensure that the indicia is printed within the longitudinal edge portions for several reasons. First, the thickness of the ink may interfere with the thermal transfer process. Second, the indicia may interfere with the image itself. However, it is difficult to print within the longitudinal edge portions, which are within approximately 3 mm of the edge during high-speed production without damaging the foil.

According to another embodiment of the present invention, the indicia includes a machine-readable indicia that is read by indicia reading means (not shown) disposed in the system. This embodiment has an added advantage of using the foil in existing apparatus that might not include indicia reading means and also can be used in a newer system that does include indicia reading means, as shown in FIG. 1. Thus, the system includes indicia reading means, such an optical sensor, magnetic sensor, or bar code sensor, for reading and relaying information regarding the donor web material.

According to a further embodiment of the present invention, the receiver web material 12, as shown in FIG. 2, includes indicia 55 along one of the longitudinal edges 18 thereof that is ink-jetted during a spooling process of the receiver web material. The indicia can include length remaining data and/or other data regarding the receiver web material. The indicia may be operator readable, such as actual length remaining, and/or machine-readable indicia, as discussed above.

A further advantage of the present invention is that the indicia is applied during the spooling process, thereby minimizing handling of the web material. Minimizing of handling of the web material is especially critical for donor web material.

While the present invention has been illustrated and described with respect to a particular embodiment thereof, it should be appreciated by those of ordinary skill in the art, that various modifications to this invention may be made without departing from the spirit and scope of the present invention. For example, although the present invention describes placing indicia on the non-film side of the foil material, the indicia can be also placed on the film side of the foil material.

What is claimed is:

1. A donor web for use in a thermal printer, comprising:
a foil having a transfer side and a non-transfer side;
a layer of thermal transfer material disposed on the transfer side of the foil material; and
indicia ink-jetted to the foil, the indicia including information of at least one of a length of used foil and a length of unused foil.

2. A donor web according to claim 1, wherein the indicia is disposed on the non-transfer side of the foil.

3. A donor web according to claim 1, wherein the indicia is disposed on a longitudinal edge portion of the foil.

4. A donor web according to claim 1, wherein the indicia is in color one of white and black so as to be visible against various colors of the thermal transfer material.

5. A donor web according to claim 1, wherein the indicia is in a color to visibly contrast with a color of the thermal transfer material.

6. A donor web according to claim 1, wherein the indicia are spaced from one another along a length of the foil.

7. A donor web according to claim 1, wherein the indicia are spaced approximately 10 cm from one another along the length of the foil.

8. A method of applying indicia on a donor web comprising the steps of:
providing a foil having a transfer side and a non-transfer side, the transfer side including a layer of thermal transfer material disposed thereon; and
depositing indicia onto the foil during a spooling operation, the indicia including information about the foil.

9. A method according to claim 8, wherein the step of depositing includes depositing indicia onto the non-transfer side of the foil.

10. A method according to claim 8, wherein the step of depositing jetting includes depositing indicia onto a longitudinal edge portion of the foil.

11. A method according to claim 8, wherein the step of depositing jetting includes spraying ink onto the foil.

12. A method according to claim 8, wherein the step of depositing includes spraying methyl ethyl ketone type ink onto the foil.

13. A method according to claim 8, wherein the step of depositing includes spraying one of white and black ink onto the foil so as to be visible against various colors of the thermal transfer material.

14. A method according to claim 8, wherein the step of depositing includes spraying a color of ink onto the foil to visibly contrast with a color of the thermal transfer material.

15. A method according to claim 8, wherein the information about the foil includes at least one of a length of used foil and a length of unused foil.

16. A method according to claim 8, wherein the step of depositing includes depositing the indicia at spaced intervals from each other along a length of the foil.

17. A method according to claim 8, wherein the step of depositing includes depositing the indicia at spaced intervals of approximately 10 cm from each other along a length of the foil.

18. A system for applying indicia onto a donor web, the system comprising:
a slitter apparatus for advancing and cutting a donor web into predetermined widths and advancing the donor web onto supply rolls, the donor web including a foil having a transfer side carrying a layer of thermal transfer material, and a non-transfer side; and
at least one inkjet head for applying indicia onto a longitudinal edge portion of the foil of the donor web at spaced intervals along a length thereof as the web is advanced onto supply rolls.

19. A system according to claim 18, wherein the at least one inkjet head includes first and second inkjet heads.

20. A system according to claim 19, wherein the first inkjet head is for applying white ink, and the second inkjet head is for applying black ink.

21. A system according to claim 19, wherein the first inkjet head is for applying an ink having a first color, and the second inkjet head is for applying an ink having a second color, the first and second colors visibly contrasting with a color of the thermal transfer material.

22. A system according to claim 18, further comprising at least one dryer disposed downstream of the at least one inkjet head in a direction of donor web advancement along the slitter apparatus for drying ink applied to the foil of the donor web.

23. A system according to claim 22, wherein the dryer includes an air blower.

24. A donor web cassette for a thermal transfer printer, the cassette comprising:
a housing including a supply roll and a take-up roll;
a donor web accommodated by the housing and coupled to the supply roll and the take-up roll, the housing defining an opening between the supply roll and the take-up roll to expose for viewing a portion of the donor web within the opening; and
indicia ink-jetted to the donor web, the indicia including information of at least one of a length of used donor web and a length of unused donor web.

25. A donor web cassette according to claim 24, wherein the donor web includes:
a foil having a transfer side and a non-transfer side;
a layer of thermal transfer material disposed on the transfer side of the foil material, and wherein the indicia is disposed on the foil.

26. A donor web cassette according to claim 25, wherein the indicia is disposed on the non-transfer side of the foil.

27. A donor web cassette according to claim 25, wherein the indicia is disposed on a longitudinal edge portion of the foil.

28. A donor web according to claim 25, wherein the indicia is in color one of white and black so as to be visible against various colors of the thermal transfer material.

29. A donor web according to claim 25, wherein the indicia is in a color to visibly contrast with a color of the thermal transfer material.

30. A donor web according to claim 25, wherein the indicia are spaced from one another along a length of the foil.

31. A donor web according to claim 25, wherein the indicia are spaced approximately 10 cm from one another along a length of the foil.

32. A web for use in a thermal printer, comprising:
a sheet material; and
indicia ink-jetted to the sheet material, the indicia including information of at least one of a length of used sheet material and a length of unused sheet material.

33. A web according to claim 32, wherein the sheet material is one of a donor web and a receiver web.
